(19) United States
(12) Patent Application Publication
(10) Pub. No.: US 2026/0311949 A1
(43) Pub. Date: Oct. 8, 2026

(54) METHODS FOR CLEANING AN ION TRANSPORT SYSTEM

(71) Applicant: Thermo Finnigan LLC, San Jose, CA (US)

(72) Inventors: Hashini Chaya Weeraratna, Milpitas, CA (US); Eloy R Wouters, San Jose, CA (US); Brian David Adamson, San Jose, CA (US)

(21) Appl. No.: 19/170,974

(22) Filed: Apr. 4, 2025

(51) Int. Cl. H01J 9/38; B08B 3/08; B08B 7/02; H01J 49/06

(52) U.S. Cl. CPC H01J 9/38; B08B 3/08; B08B 7/028; H01J 49/062

(57) ABSTRACT

The present disclosure generally provides methods of cleaning an ion transport systems of mass spectrometer systems. The methods include removing an ion transport system including at least an ion optic from a vacuum system of a mass spectrometer. The ion transport system includes a passive electronic component electrically coupled to the at least an ion optic. The ion transport system is disposed in a cleaning composition including about 0.01 wt% to about 10 wt% of a peroxide. The peroxide includes hydrogen peroxide, sodium percarbonate, or a combination thereof. The ion transport system is washed in a first rinse composition.

### TECHNICAL FIELD

The present disclosure relates to mass spectrometry. More particularly, the present disclosure relates to methods for cleaning ion transport systems in a mass spectrometer system.

### BACKGROUND

Various approaches have been proposed in the mass spectrometry arts for improving ion transport efficiency into low vacuum regions. For example, a mass spectrometer system having an Atmospheric Pressure Ionization (API) ion source, e.g., an electrospray ionization (ESI) source, a heated electrospray ionization (H-ESI) source, an atmospheric pressure chemical ionization (APCI) source, an atmospheric pressure matrix assisted laser desorption (MALDI) source, a photoionization source, or a combination thereof, can be used to generate ions from a sample.

“Ion optical elements” otherwise known as “ion optics”, e.g., radio frequency (RF) stacking ring ion guides, ion funnels, a series of rods or bars having RF waveforms applied to form multipoles, or a combination thereof, guide and confine the generated ions inside the mass spectrometer system. Traditionally, ion optics are comprised of metal elements in combination with ceramic or plastic structures to maintain their relative alignment serve to electrically insulate them from one another, thereby allowing the ion optical elements to operate in various sub-atmospheric regions to bring ions from the atmospheric inlet to the mass analyzer. Generally, printed circuit boards (PCBs) are mechanically coupled to the ion optics, in which various passive components including, e.g., resistors, capacitors, or a combination thereof, are mounted to the printed circuit boards (PCBs). During the introduction of the ions from the atmospheric inlet to the mass analyzer ion optics are exposed to the samples and/or matrices that are being analyzed in the mass spectrometer causing a deposit of unionized sample and/or matrix, and thereby requiring periodic cleaning during regular maintenance.

Conventional cleaning protocols include removing the ion optics from a vacuum system of a mass spectrometer, submerging the ion optics into a cleaning solution, mechanically scrubbing the ion optics to remove the deposited unionized sample and/or matrix, sonicating the ion optics, and rinsing the ion optics to remove residual cleaning solution and/or deposited unionized sample and/or matrix. Unfortunately, removing the ion optics from the vacuum system generally includes a labor-intensive process of dissociating various passive components, e.g., resistors, capacitors, or a combination thereof, mounted to one or more printed circuit boards (PCBs) from the plurality of ion optical elements, requiring careful realignment to restore performance of the mass spectrometer. Moreover, some of the passive components are unable to be dissociated from the plurality of ion optical elements and are subject to the cleaning solutions. The cleaning solutions often include reactive compositions, e.g., sulfonic acids, formic acids, citric acids, and/or bases, and can damage the passive components, printed circuit boards (PCBs), and/or masks, e.g., solder joints coupling the passive components to the PCBs, or ion optics, thereby decreasing the robustness and/or longevity of the mass spectrometer system after performing routine maintenance due to etching of the masks or solder joints.

Accordingly, what is needed is an improved method for cleaning ion optics.

### SUMMARY

In an aspect, the present disclosure generally provides methods of cleaning an ion transport systems of mass spectrometer systems. The methods include removing an ion transport system including at least an ion optic from a vacuum system of a mass spectrometer. The ion transport system includes a passive electronic component electrically coupled to the at least an ion optic. The ion transport system is disposed in a cleaning composition including about 0.01 wt% to about 10 wt% of a peroxide. The peroxide includes hydrogen peroxide, sodium percarbonate, or a combination thereof. The ion transport system is washed in a first rinse composition.

In another aspect, the present disclosure generally provides methods of cleaning ion transport systems of mass spectrometer systems. The methods include removing an ion transport system including at least an ion optic from a vacuum system of a mass spectrometer. The ion transport system includes a passive electronic component mounted to a mounting device via one or more soldering joints. The passive electronic component is electrically coupled to the at least an ion optic. The ion transport system is disposed in a cleaning composition. The cleaning composition includes about 0.01 wt% to about 10 wt% of a peroxide. The peroxide includes hydrogen peroxide, sodium percarbonate, or a combination thereof. The ion transport system is washed in a first rinse composition.

In another aspect, the present disclosure generally provides methods of cleaning ion transport systems of mass spectrometer systems. The methods include removing an ion transport system including at least an ion optic from a vacuum system of a mass spectrometer. The ion transport system includes a passive electronic component electrically coupled to the at least an ion optic. The ion optic includes an ion guide, an ion funnel, a quadrupole, a multipole, an ion lens, or a combination thereof. The ion transport system is disposed in a cleaning composition. The cleaning composition includes about 0.01 wt% to about 10 wt% of a peroxide. The peroxide includes hydrogen peroxide, sodium percarbonate, or a combination thereof. The ion transport system is washed in a first rinse composition.

### BRIEF DESCRIPTION OF THE DRAWINGS

The above noted and various other aspects of the present invention will become apparent from the following description which is given by way of example only and with reference to the accompanying drawings, not necessarily drawn to scale, in which:

FIG. 1A is a schematic longitudinal cross section of a sixth ion transport system including an ion transport apparatus according to aspects of the present disclosure.

FIG. 1B is a schematic transverse cross section of the ion transport apparatus of FIG. 1A, as viewed on cross-section H-H' according to aspects of the present disclosure.

FIG. 2 is a schematic illustration of a generalized mass spectrometer system according to aspects of the present disclosure.

FIG. 3 is a flow diagram representing a method for cleaning an ion transport system according to aspects of the present disclosure.

FIG. 4A is a schematic illustration of a reference passive electronic component, according to aspects of the present disclosure.

FIG. 4B is a schematic illustration of a passive electronic component cleaned using a conventional cleaning process, according to aspects of the present disclosure.

FIG. 4C is a schematic illustration of a passive electronic component cleaned using a cleaning process according to aspects of the present disclosure.

FIG. 5A is a schematic illustration of a reference ion optic, according to aspects of the present disclosure.

FIG. 5B is a schematic illustration of an ion optic cleaned using a conventional cleaning process, according to aspects of the present disclosure.

FIG. 5C is a schematic illustration of an ion optic cleaned using a cleaning process according to aspects of the present disclosure.

### DETAILED DESCRIPTION

The present disclosure generally provides methods for cleaning an ion transport system. The present disclosure includes cleaning the ion transport system using one or more peroxides, e.g., a hydrogen peroxide and/or an inorganic peroxide such as a percarbonate, e.g., sodium percarbonate. The one or more peroxides can produce oxygen, O₂, in solution thereby reducing the reactivity with the passive components due to lack of hydrogen interaction with the printed circuit boards (PCBs), solder joints, and/or masks of the ion optics. The oxygen removes deposited unionized sample and/or matrix with the same and/or greater efficiency compared to conventional cleaning processes, thereby increasing the robustness and/or longevity of the mass spectrometer system after performing routine maintenance. Additionally, a reduction in the cleaning process time and/or re-alignment complications is achieved due to the reduced and/or eliminated time for disassembly of the ion optics from the ion transport system, thereby increasing cleaning process speed while maintaining mass spectrometer performance compared to conventional cleaning processes.

Advantageously, cleaning the ion transport system using the one or more peroxides can be standardized for a plurality of samples and matrices such that a one or a few cleaning solutions can be utilized during a cleaning process, thereby reducing the number of cleaning solutions and/or solvents to achieve a similar or better cleanliness compared to conventional cleaning processes. Additionally, the one or more peroxides of the present disclosure may be more accessible compared to conventional cleaning solvents, thereby reducing and/or eliminating regulatory challenges to obtain conventional cleaning solvents.

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of candidates or alternatives is merely illustrative, not limiting, unless implicitly or explicitly understood or stated otherwise. As used herein, the term “DC”, when referring to a voltage applied to one or more electrodes and/or ion optics of a mass spectrometer component (such as an ion funnel), does not necessarily imply the imposition of or the existence of an electrical current through those electrodes but is used only to indicate that the referred-to applied voltage either is static or, if non-static, is non-oscillatory and non-periodic. The term “DC” is thus used herein to distinguish the referred-to voltage(s) from applied periodic oscillatory voltages, which themselves may be referred to as either “RF” or “AC” voltages. As used herein, the term “major portion”, as used herein, refers to a portion that is greater than fifty percent.

This document includes discussion of various ion conduit structures – referred to as “ion optics”, “ion tunnels”, and “ion funnels” – that permit ions to migrate through an internal volume of the conduit structure along a longitudinal direction while restricting ions from escaping from the internal volume along transverse or radial dimensions or directions. Because ions are prevented from escaping from the internal volume along certain dimensions or directions, the internal volume is also referred to as a “trapping volume”. As used herein, the terms “ion optics”, “ion tunnels”, and “ion funnels” refer to the combination of the physical conduit structure and the internal volume within which ions migrate longitudinally while being trapped transversely/radially. As used herein, the terms “ion optic section”, “ion tunnel section”, and “ion funnel section” refer to an ion tunnel structure or ion funnel structure, respectively, that is a portion or component of a larger ion transport apparatus which, itself, may comprise one or more ion tunnel and/or ion funnel component portions or sections. As used herein, the term “ion funnel” refers to an ion conduit structure within which the cross-sectional area of the internal volume progressively decreases across the length of its central longitudinal axis or across a portion of the length of a central longitudinal axis of a containing ion transport structure. Likewise, as used herein, the term “ion tunnel” refers to an ion conduit structure that maintains a constant cross-sectional area across its central longitudinal axis or across a portion of a central longitudinal axis of a containing ion transport apparatus.

The use of the terms “ion optic”, “ion tunnel”, and “ion funnel” are not intended to restrict the cross-sectional shape of the internal volume of the referred to conduit structure to any particular shape. Thus, as the terms are used herein, an ion tunnel, an ion optic, or ion funnel may comprise any regular or irregular cross-sectional shape, such as circular, rectangular, etc. If, in cross section, the trapping volume of an ion tunnel has radial symmetry or an n-fold axis of rotational symmetry, where n ≥ 2, then a central longitudinal axis is taken as the axis of radial or n-fold rotational symmetry. Otherwise, if, in cross section, the trapping volume has a single plane of mirror symmetry, the central longitudinal axis of the ion tunnel is taken as the intersection of the plane of mirror symmetry with the trapping volume. Otherwise, if, in cross section, the trapping volume is asymmetric, the central longitudinal axis is taken as the locus of the centers of mass, taken at all cross sections, of uniform-density laminae having the same shape as the shape of the respective trapping volume cross section.

The discussion in this document refers to various axes and planes that are defined with reference to geometric features of physical objects, such as slots, cutouts, apertures, etc. Such various axes and planes are to be understood as extending “to infinity” beyond the feature(s) of physical objects with respect to which they are defined. Accordingly, referred-to intersections of or geometric relationships between such axes and/or planes are not necessarily within the bounds of the defining features or physical objects. Further, as used herein, a statement that a first line or axis is coincident with a second line or axis means that all points of the second line or axis are also points of the first line or axis. Still further, as used herein, a statement that a line or axis is contained within a plane means that all points of the line are also points of the plane.

### SYSTEM

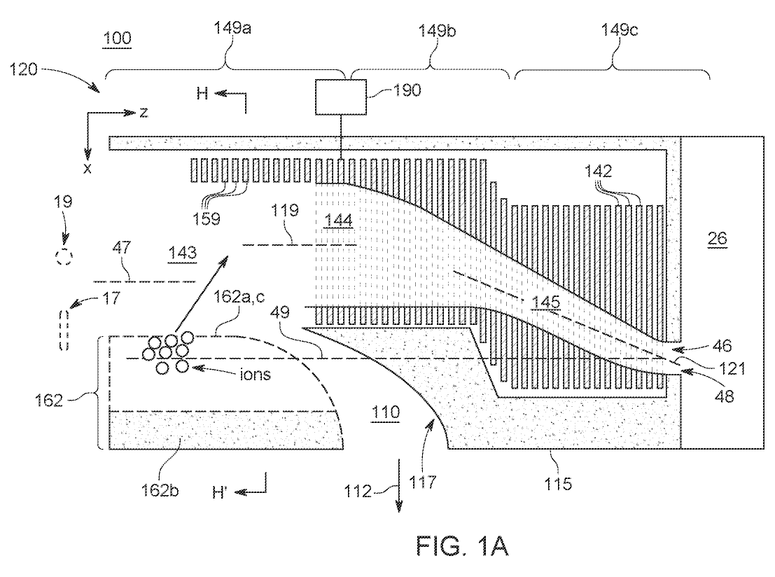

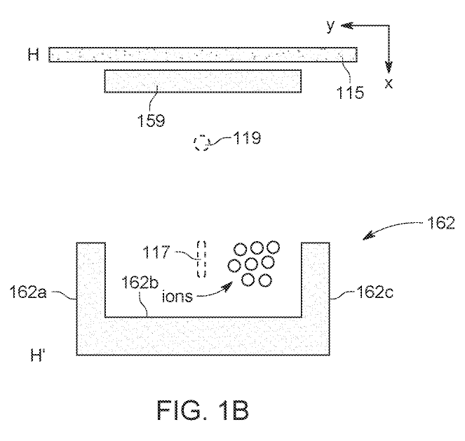

FIGS. 1A and 1B are a schematic side-elevational view and a schematic transverse cross section, respectively, of an ion transport system 100 including an ion transport apparatus 120 in accordance with the present disclosure. As shown in FIGS. 1A and 1B, the ion transport apparatus 120 can include an ion funnel. While FIGS. 1A and 1B represent an ion funnel, the ion transport apparatus 120 can include one or more of an ion funnel, an ion optic, an ion guide (e.g., a multipole ion guide or a quadrupole ion guide), an ion trap, or a combination thereof.

The dashed line schematically depicts the outline of a cross-sectional view of a hollow interior volume of the ion transport apparatus 120, where the cross section is taken to include the apparatus’ central longitudinal axis 47. The ion transport apparatus 120 includes a set of stacked parallel plate electrodes 142, each such electrode comprising at least one aperture, the apertures of which define a funnel-shaped volume 145 that corresponds to a funnel section of the apparatus and, possibly, a short tunnel-shaped volume 144 having a longitudinal axis 119.

The apertures of plate electrodes 142 can vary in progression through the ion transport apparatus 120 from its inlet to its outlets. The apertures of the plate electrodes 142 define the short tunnel-shaped volume 144 and the funnel-shaped volume 145. Accordingly, the plate electrodes and their apertures in electrode sections 149b and/or 149c define an ion tunnel section of the ion transport apparatus 120. Axis 47, which is a central longitudinal axis of the ion transport apparatus 120 is also a central longitudinal axis of the ion tunnel section as well as of the adjacent truncated funnel section of the apparatus, the latter section being defined by the electrodes and apertures of electrode section 149c. The apertures of the plate electrodes of section 149b define the shape of the short tunnel-shaped volume 144 of the hollow interior volume. The plate electrodes of section 149b have variable diameters that progressively decrease with increasing distance from the entrance aperture. The collection of apertures within section 149c define the funnel-shaped volume 145.

A portion of the apertured electrodes are absent from a region of the apparatus that is upstream from the ion funnel and/or ion tunnel volumes and that is downstream from an auxiliary transfer tube 19, if present. These “missing” electrodes are replaced by an optional set of ion carpet electrodes 159 that are configured to receive oscillatory Radio Frequency (RF) voltages, as shown in FIG. 1B. The oscillatory RF voltage waveforms may be applied to the electrode plates, with waveforms of immediately adjacent plates being out of phase by π radians. When energized with such RF voltages, the ion carpet electrodes 159 prevent loss of ions through the side of the apparatus along which the ion carpet electrodes are disposed. Accordingly, a pseudopotential well is formed in the vicinity of central longitudinal axis 47.

A slotted-bore ion transfer tube 17 couples a sub-volume 143 of the ion transport apparatus 120 to the gas and/or ions from an ionized sample. The gas and/or ions can include a mixture of neutral gas molecules, charged solvent droplets, and ions derived from the ionized sample. The ion transfer tube may comprise a conventional round bore or lumen for transporting the gas and/or ions. Alternatively, the ion transfer tube 17 may comprise a slot or may comprise multiple straight or curved slots or may comprise one or more bores or channels having cross sections that comprise one or more obround or slot-shaped lobes. Optionally, an auxiliary transfer tube 19 may be provided to supply an auxiliary gas flow that optionally includes ions of a calibrant material into the sub-volume 143. The small, dotted circle and oval represent projections, parallel to the axis 47, of the locations of the lumens of the transfer tubes 19 and 17, onto the plane of the depicted electrode plate. In an embodiment, the slotted-bore ion transfer tube 17 has a bore in the form of a single straight slot.

The slotted-bore ion transfer tube 17 may be oriented such that the central longitudinal axis 47 is contained within the slot plane of the ion transfer tube. As illustrated in FIG. 1A, the axis 121 of the funnel-shaped volume 145 of the ion transport apparatus 120 may be disposed at an angle to the central longitudinal axis 47 (or to a central longitudinal axis of an upstream ion tunnel section). The angle of the axis 121 is such that the ion outlet aperture 46 is disposed along a projection line 49, that is taken parallel to the central longitudinal axis 47 of the ion outlet of the slotted-bore ion transfer tube 17.

The position of the slotted-bore ion transfer tube 17 is schematically indicated by an elongated slot that indicates that the long dimension of the slot is aligned parallel to the x-z plane (e.g., the plane of the printed page) of the ion transport apparatus 120, such that the long dimension of the slot is oriented parallel to the denoted x-axis. The auxiliary transfer tube 19, if present, has a conventional round bore, the axis of which is preferably aligned parallel to the central longitudinal axis 47 of the funnel.

The ion transport apparatus 120 can include a plurality of an outlet apertures. In some embodiments, the ion transport apparatus 120 includes an ion outlet aperture 46 and a gas exhaust channel 110, the gas exhaust channel 110 is defined by a gap between a repeller electrode assembly 162 and a gas diverter surface 117 of a gas diverter structure 115, the latter of which may comprise a portion of a wall or housing of the apparatus. The ion outlet aperture 46 may receive ions and a small proportion of the inlet gas from funnel-shaped volume 145 and delivers the ions and gas to intermediate vacuum chamber 26 via an aperture 48. The gas exhaust channel 110 receives a greater proportion of the inlet gas as well as some ions from the sub-volume 143 and exhausts the gas and ions as exhaust flow 112. The gas exhaust channel 110 may be coupled to a vacuum pump.

The repeller electrode assembly 162 may comprise a box-like structure as depicted in the transverse cross-sectional view of the system provided in FIG. 1B. As shown in FIG. 1B, the repeller electrode assembly 162 may be comprise two wall sections 162a, 162c and a basal section 162b that define an internal gas channel that guides gas and droplets that emerge from an slotted-bore ion transfer tube 17 to the gas exhaust channel 110. The wall and basal sections may be formed as a single integral piece, as shown in FIG. 1B or, alternatively, may be separate from one another.

An electronic component 190, e.g., passive electronic components, may be electrically coupled to an electrode plate of the plurality of electrode plates of sections 149a, 149b, and/or 149c. The electronic component 190 can include a resistor and/or a capacitor. For example, the electronic component 190 can include a resistor and/or a capacitor electrically coupled to an electrode plate of section 149a, an electrode plate of section 149b, and/or an electrode plate of section 149b. In some embodiments, the electronic components 190 are configured to apply a drag field to regulate the speed of the ions flowing through sections 149a, 149b, and/or 149c. Without being bound by theory, an increase in drag field applied by the one or more electronic components 190 can reduce a speed of the ions traveling through sections 149a, 149b, and/or 149c. Additionally, and without being bound by theory, a decrease in drag field applied by the one or more electronic components 190 can increase a speed of the ions traveling through sections 149a, 149b, and/or 149c.

While only one electronic component 190 is displayed in FIG. 1A, the present disclosure contemplates a plurality of electronic components electrically coupled to electrodes plate of sections 149a, 149b, and/or 149c.

The electronic component 190 is coupled, e.g., using mechanical and/or electrical means such as soldering, to a mounting device (not shown) to secure the electronic component 190 to the electrode plate of the plurality of electrode plates of sections 149a, 149b, and/or 149c. The mounting device can include a printed circuit board (PCB) or other mounting structure such as a ceramic substrate. The electronic component 190 may be coupled to the mounting device such that the electronic component can receive a voltage to apply the drag field to the ions flowing through sections 149a, 149b, and/or 149c. In some embodiments, the electronic component 190 are mounted using a solder connection between the electronic component to the mounting device. The solder connection may be covered with a mask, e.g., a solder mask, to prevent oxidation or degradation of the solder connection, thereby improving the ability to maintain a drag field within the ion transport system.

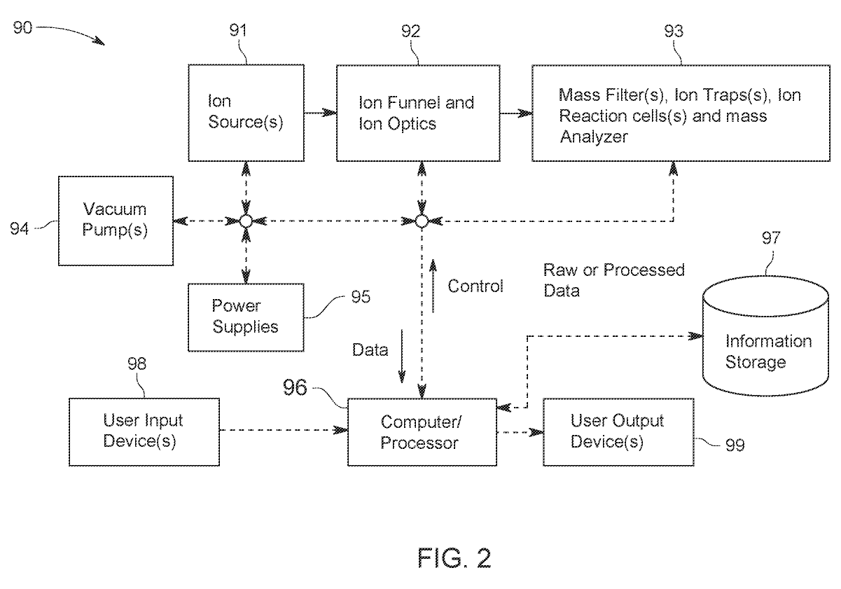

FIG. 2 schematically illustrates a generalized mass spectrometer system 90 on which methods in accordance with the present disclosure may be practiced. The mass spectrometer system includes a set of various hardware components, e.g., ion source(s) 91, an ion transport apparatus and other ion optical components 92 as taught herein, one or more mass filters, ion traps and/or mass analyzers 93, one or more vacuum pumps 94 and one or more power supplies 95. Various of the hardware components 91-95 comprise electrodes, electrical components or motors and may comprise various sensors and detectors, such as temperature sensors, pressure sensors, current sensors, ion detectors, etc. The various electrodes, other electrical components, motors and sensors are electrically or electronically coupled to a computer or other digital-logic controller processor apparatus 96. The electrical or electronic couplings, illustrated by dashed arrows in FIG. 2, convey control signals to the various hardware components 91-94 and may also convey data from the hardware components to the computer or controller 96. The computer or controller is also coupled to one or more data storage devices 97, various user input devices 98 such as keyboards, terminals, etc. and various user output devices 99.

In the context of the present disclosure, the controller 96 may transmit control signals to the ion source(s) 91 to generate and provide ions of sample and/or calibrant materials to and through the ion funnel and other ion optical components. The ion funnel may comprise various of the features, possibly in combination, described in the above descriptions and accompanying drawings. The controller 96 may also transmit control signals to the one or more vacuum pumps 94 to evacuate the ion funnel and other mass spectrometer components. Pressure and temperature sensors within the ion funnel and/or other mass spectrometer components may transmit data back to the controller that is used by the controller to determine when the ion funnel and other mass spectrometer components are available and ready to measure data. Similarly, voltage sensors or ion current sensors within or associated with the ion funnel may transmit data to the controller that is used by the controller to control RF and DC voltages applied to plate electrodes and or repeller electrodes of the funnel in order to optimize ion transmission through the funnel to downstream mass spectrometer components. Various sensor data, operational configuration data and experimental data may be stored in the information storage device 97.

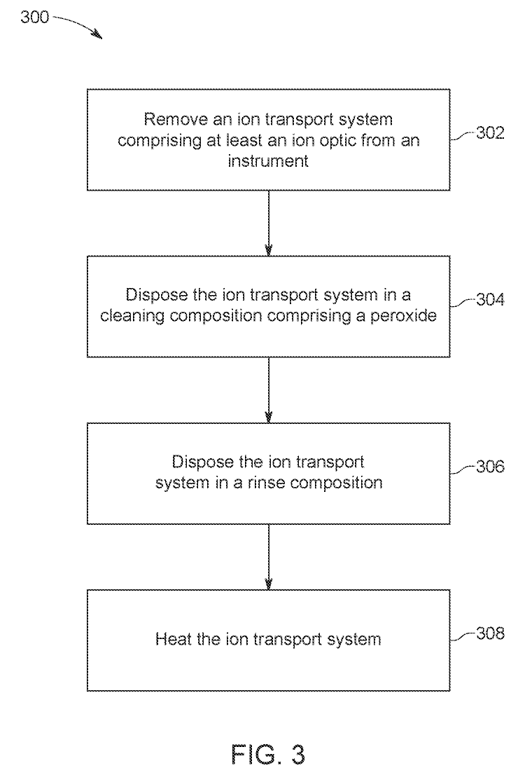

FIG. 3 schematically illustrates a method 300 of cleaning an ion transport system according to various aspects of the present disclosure. At operation 302, an ion transport system 100 is removed from a vacuum system of a mass spectrometer. The ion transport system 100 includes at least an ion optic, e.g., a plate electrode of a set of stacked parallel plate electrodes 342. The ion transport system 100, includes an ion transfer tube 17 and an ion outlet aperture 46.

At operation 304, the ion transport system 100 is disposed in a cleaning composition. The cleaning composition can include an aqueous solvent, e.g., water. The cleaning composition includes about 0.01 wt% to about 10 wt% of a peroxide, e.g., about 0.01 wt% to about including hydrogen peroxide, sodium percarbonate, or a combination thereof. In some embodiments, the peroxide includes sodium percarbonate. In some embodiments, an electronic component 190 electrically coupled to the ion optic and/or ion funnel 620 is disposed in the cleaning composition. The electronic component 190 can include a passive electronic component, e.g., a capacitor or a resistor, that is mounted to a mounting device, e.g., a PCB, via one or more soldering joints. A solder mask may be disposed over the one or more soldering joints, in which the solder mask may be a polymer coating disposed over the soldering joints that are configured to protect the one or more soldering joints from oxidation or other degradation. Without being bound by theory, the cleaning composition, including about 0.01 wt% to about 10 wt% of a peroxide, may include reduced and/or neutral reactivity towards the electronic component 190, thereby allowing for reduced oxidation and/or degradation of the solder masks and/or soldering joints. A reduced oxidation and/or degradation may allow for prolonged operational use of the mass spectrometer following a cleaning process.

Optionally, at operation 304, the method includes sonicating the ion transport system 100 in the cleaning composition. The sonication can occur for a period of time of about 0.1 hours to about 24 hours. Without being bound by theory, sonicating the ion transport system for a period of about 0.1 hours to about 24 hours can allow for improved cleaning efficiency and removal of debris and/or deposits of neutral ions and/or ions that are not guided through the ion transport system 100. In some embodiments, sonicating the ion transport system 100 can include operating a sonicator at a frequency of about 1 Hz to about 100 kHz. Optionally, at operation 304, the method includes heating the cleaning composition. The cleaning composition may be heated to a temperature of about 20 degrees Celsius (℃) to about 50 (℃). Without being bound by theory, heating the cleaning composition to a temperature of about 20 degrees Celsius (℃) to about 50 (℃) can allow for improved cleaning efficiency and removal of debris and/or deposited unionized sample and/or matrix.

Optionally, a mechanical agitation may be applied to the ion transport system 100. The mechanical agitation can include scrubbing, rubbing, pressing, and/or a combination thereof. For example, the mechanical agitation can include scrubbing the ion transport system 100 with a brush for a predetermined period of time, e.g., about 0.1 hours to about 24 hours, to remove and/or reduce debris and/or deposited unionized sample and/or matrix.

At operation 306, the ion transport system 100 is washed in a first rinse composition. The first rinse composition can include a passivation composition, e.g., a composition to neutralize the cleaning composition. For example, the first rinse composition can include an acidic composition such as citric acid, formic acid, or acetic acid in an aqueous solvent, e.g., water. In some embodiments, the acidic composition can include about 0.01 wt% to about 10 wt% of acid in the aqueous solvent. The first rinse composition can include a neutral composition, e.g., an aqueous solvent such as water and/or an alcohol, e.g., methanol, ethanol, isopropyl alcohol, or a combination thereof. In some embodiments, the neutral composition can include methanol. In some embodiments, the neutral composition can include water.

Optionally, at operation 306, the ion transport system 100 is washed in a second rinse composition. The second rinse composition can include a neutral composition, e.g., an aqueous solvent such as water and/or an alcohol, e.g., methanol, ethanol, isopropyl alcohol, or a combination thereof. In some embodiments, the neutral composition can include water. In some embodiments, the neutral composition can include methanol. Optionally, at operation 306, the ion transport system 100 is washed in a third rinse composition. The third rinse composition can include a neutral composition such as an alcohol, e.g., methanol, ethanol, isopropyl alcohol, or a combination thereof. For example, the third rinse composition can include methanol. In some embodiments, sonication may be applied to the ion transport system 100 while washing the ion transport system 100 in the first rinse composition, the second rinse composition, and/or the third rinse composition.

Optionally, at operation 308, the ion transport system 100 may be heated. The ion transport system 100 may be heated to a temperature of about 20 degrees Celsius (℃) to about 50 (℃). The ion transport system 100 may be heated for a period of time of about 0.1 min to about 24 hours. Optionally, the ion transport system 100 may be dried using an inert gas. The inert gas can include nitrogen, argon, helium, hydrogen, or a combination thereof. In some embodiments, the inert gas include nitrogen. In some embodiments, a flow of about 30 ml/min to about 400 ml/min may be administered to the ion transport system 100. The flow of the inert gas may occur for a period of time of about 2 minutes about 5 minutes.

### EXAMPLES

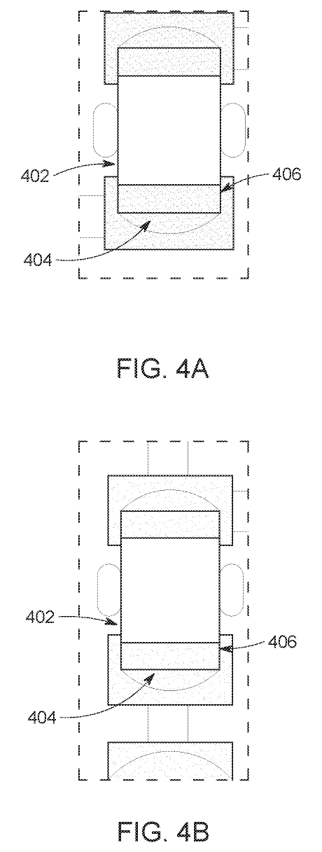

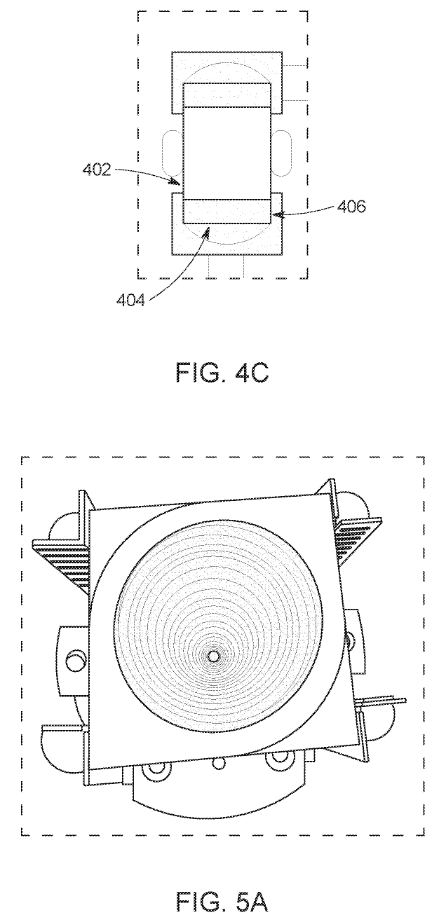

FIG. 4A shows an exemplary electronic component prior to performing a cleaning process. The exemplary electronic component includes a passive electronic component 402, a solder joint 404, and a solder mask 406. FIG. 4B shows the exemplary electronic component after performing a cleaning process according to the present disclosure. The conventional cleaning process included sonicating an ion transport system including an electronic component for 1 hour in a cleaning composition including 10 wt% citric acid in water. The ion transport system was then mechanically agitated by brushing. The ion transport system was then sonicated for 5 minutes in water, followed by another sonication for minutes in methanol. The ion transport system was then dried using nitrogen and/or heat. FIG. 4C shows the exemplary electronic component after performing a conventional cleaning process. The cleaning process according to the present disclosure included sonicating an ion transport system including an electronic component for 1 hour in a cleaning composition including 2 wt% sodium percarbonate in water, followed a 2-hour rest period in the composition. The ion transport system was then mechanically agitated by brushing. The ion transport system was then sonicated for 1 hour in a composition comprising 10 wt% citric acid in water, followed by sonication for 5 minutes in water, and another sonication for 5 minutes in methanol. The ion transport system was then dried using nitrogen and/or heat.

As shown in FIGS. 4B and 4C, the conventional cleaning process resulted in etching of the solder mask 406 and of the solder joint 404, while the cleaning process of the present disclosure maintained the solder mask 406 and the solder joint 404 such that minimal and/or no degradation occurred.

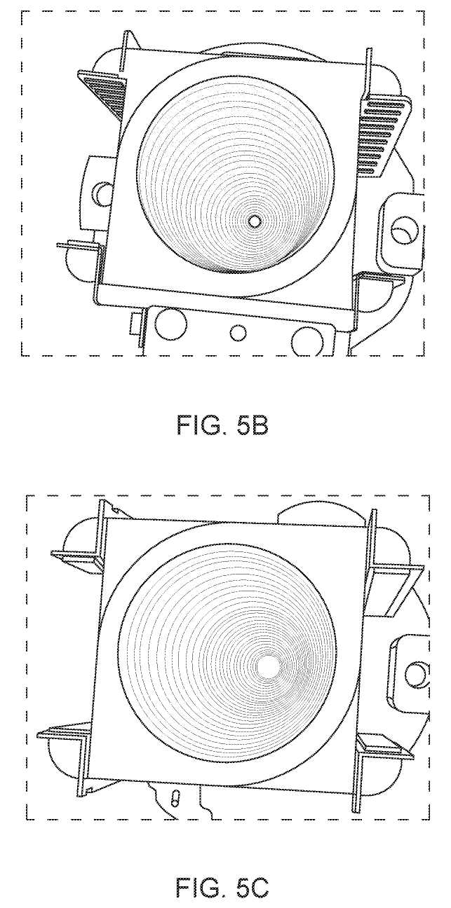

A reduction in the deposited unionized sample and/or matrix occurred when cleaning the ion transport system using the cleaning processes of the present disclosure, as shown in FIGS. 5A-5C.

The discussion included in this application is intended to serve as a basic description. The present invention is not intended to be limited in scope by the specific embodiments described herein, which are intended as single illustrations of individual aspects of the invention. Functionally equivalent methods and components are within the scope of the invention. Various other modifications of the invention, in addition to those shown and described herein will become apparent to those skilled in the art from the foregoing description and accompanying drawings.

Not all of the various illustrated technical features and components are depicted and described for all possible embodiments. Features or components described for fewer than all of the illustrated embodiments are considered to be applicable to other embodiments, provided that they are not incompatible with those other embodiments. Additionally, although electrode apertures are illustrated as circular or partially circular in shape, other aperture shapes, such as oval shapes, are possible.

The electrodes themselves need not be formed as square or rectangular metal plates. In alternative embodiments, both plate and ring electrodes may be replaced by flat planar or ring-like films, foils or coatings that are supported on a rigid backing substrate, such as printed circuit board material.

Overall, the present disclosure provides cleaning an ion transport system using one or more peroxides, e.g., a hydrogen peroxide and/or an inorganic peroxide such as a percarbonate, e.g., sodium percarbonate to remove deposited unionized sample and/or matrix with the same and/or greater efficiency compared to conventional cleaning processes. The present disclosure reduces reactivity of the cleaning solvents with the passive electronic components, printed circuit boards (PCBs), solder joints, and/or masks of the ion optics, thereby increasing the robustness and/or longevity of the mass spectrometer system after performing routine maintenance. Additionally, a reduction in a cleaning process time and/or a re-alignment complication is achieved due to the reduced and/or eliminated disassembly procedures, thereby increasing cleaning process speed while maintaining mass spectrometer performance compared to conventional cleaning processes. Moreover, cleaning the ion transport system using the one or more peroxides can be standardized for a plurality of samples and matrices such that a one or a few cleaning solutions are utilized during a cleaning process, thereby reducing the number of cleaning solutions and/or solvents to achieve a similar or better cleanliness compared to conventional cleaning processes. The one or more peroxides of the present disclosure may be more accessible compared to conventional cleaning solvents, thereby reducing and/or eliminating regulatory challenges to obtain conventional cleaning solvents.

Any patents, patent applications, patent application publications or other literature mentioned herein are hereby incorporated by reference herein in their respective entirety as if fully set forth herein, except that, in the event of any conflict between the incorporated reference and the present specification, the language of the present specification will control.

What is claimed is:

1. A method of cleaning an ion transport system of a mass spectrometer system, comprising:
removing an ion transport system comprising at least an ion optic from a vacuum system of a mass spectrometer, wherein the ion transport system comprises a passive electronic component electrically coupled to the at least an ion optic;
disposing the ion transport system in a cleaning composition comprising about 0.01 wt% to about 10 wt% of a peroxide comprising hydrogen peroxide, sodium percarbonate, or a combination thereof; and
washing the ion transport system in a first rinse composition.

2. The method of claim 1, wherein washing the ion transport system in the first rinse composition further comprises heating the ion transport system.

3. The method of claim 2, wherein heating the ion transport system further comprises drying the ion transport system using an inert gas.

4. The method of claim 1, wherein the ion optic comprises an ion guide, an ion funnel, a quadrupole, a multipole, an ion lens, or a combination thereof.

5. The method of claim 1, wherein the passive electronic component is mounted to a mounting device via one or more soldering joints.

6. The method of claim 5, wherein a solder mask is disposed over the one or more soldering joints.

7. The method of claim 1, wherein the passive electronic component comprises a capacitor or a resistor.

8. The method of claim 1, wherein disposing the ion transport system in the cleaning composition further comprises sonicating the ion transport system in the cleaning composition for a period of about 0.1 hours to about 24 hours.

9. The method of claim 1, wherein the method further comprises heating the cleaning composition at a temperature of about 20 degrees Celsius (℃) to about 50 (℃).

10. The method of claim 1, wherein washing the ion transport system in the first rinse composition further comprises washing the ion transport system in a second rinse composition, wherein the second rinse composition comprises an alcohol.

11. The method of claim 10, wherein washing the ion transport system further comprises sonicating the ion transport system in the first rinse composition or the second rinse composition.

12. A method of cleaning an ion transport system of a mass spectrometer system, comprising:
removing an ion transport system comprising at least an ion optic from a vacuum system of a mass spectrometer, wherein the ion transport system comprises a passive electronic component mounted to a mounting device via one or more soldering joints, wherein the passive electronic component is electrically coupled to the at least an ion optic,
disposing the ion transport system in a cleaning composition comprising about 0.01 wt% to about 10 wt% of a peroxide comprising hydrogen peroxide, sodium percarbonate, or a combination thereof;
washing the ion transport system in a first rinse composition.

13. The method of claim 12, wherein the passive electronic component is a capacitor or a resistor.

14. The method of claim 12, wherein a solder mask is disposed over the one or more soldering joints.

15. The method of claim 12, wherein disposing the ion transport system in the cleaning composition further comprises sonicating the ion transport system in the cleaning composition for a period of about 0.1 hours to about 24 hours.

16. The method of claim 12, wherein the method further comprises heating the cleaning composition at a temperature of about 20 degrees Celsius (℃) to about 50 (℃).

17. The method of claim 12, wherein washing the ion transport system in the first rinse composition further comprises washing the ion transport system in a second rinse composition, wherein the second rinse composition comprises an alcohol.

18. The method of claim 17, wherein washing the ion transport system further comprises sonicating the ion transport system in the first rinse composition or the second rinse composition.

19. The method of claim 12, wherein heating the ion transport system further comprises drying the ion transport system using an inert gas.

20. A method of cleaning an ion transport system of a mass spectrometer system, comprising:
removing an ion transport system comprising at least an ion optic from a vacuum system of a mass spectrometer, wherein the ion transport system comprises a passive electronic component electrically coupled to the at least an ion optic comprising an ion guide, an ion funnel, a quadrupole, a multipole, an ion lens, or a combination thereof,
disposing the ion transport system in a cleaning composition comprising about 0.01 wt% to about 10 wt% of a peroxide comprising hydrogen peroxide, sodium percarbonate, or a combination thereof;
washing the ion transport system in a first rinse composition.
